(19) United States
(12) Patent Application Publication
(10) Pub. No.: US 2025/0128582 A1
(43) Pub. Date: Apr. 24, 2025

(54) TRUCK COVERING SYSTEM

(71) Applicant: Cixi City Liyuan Auto Parts Co., Ltd, CIXI (CN)

(72) Inventor: Enli XU, CIXI (CN)

(21) Appl. No.: 18/825,325

(22) Filed: Sep. 5, 2024

(30) Foreign Application Priority Data
Oct. 23, 2023 (CN) 202322853553.9
May 27, 2024 (CN) 202421188858.0
Jun. 24, 2024 (CN) 202421457249.0

(51) Int. Cl. B60J 7/14; B60J 7/19

(52) U.S. Cl. CPC B60J 7/141; B60J 7/198

(57) ABSTRACT

A truck covering system, comprising a truck compartment frame mechanism, configured to be mounted on a side wall of a truck compartment, the truck compartment frame mechanism having an open space; a covering system, mounted on the truck compartment frame mechanism, the covering system consisting of one or more panels, the covering system having at least a lying position and a standing position relative to the truck compartment frame mechanism; a clamp mechanism, the clamp mechanism being capable of respectively abutting against the truck compartment frame mechanism and the covering system, the clamp mechanism and the covering system having a spacing therebetween; a fastening mechanism, the fastening mechanism acting on the clamp mechanism and the covering system to increase or decrease the spacing; and a latch mechanism, attached to the covering system, and the latch mechanism and the truck compartment frame mechanism to be releasably engaged.

### CROSS-REFERENCE TO RELATED APPLICATIONS

This application claims priority under 35 U.S.C. § 119(a) to Chinese Patent Applications No. 202322853553.9 filed on Oct. 23, 2023; No. 202421188858.0 filed on May 27, 2024; and No. 202421457249.0 filed on Jun. 24, 2024. The above applications are hereby incorporated by reference for all purposes as if fully set forth herein.

### TECHNICAL FIELD

The present invention generally relates to methods, systems, and apparatus for implementing a tailgate system.

### BACKGROUND ART

Traditionally, Pickup trucks are widely used vehicles that can transport cargo and passengers. Passengers are typically placed in the truck cab, while cargo can be stored in the truck bed. Truck beds are typically rectangular and open to the environment to facilitate loading and transporting large and/or oddly shaped cargo. However, exposing the truck bed to the elements may leave the truck bed and/or cargo unprotected. For example, the truck bed and/or cargo may be exposed to dust, precipitation (e.g., rain, snow, hail), etc. Therefore, some truck owners purchase truck covers to protect the truck bed and the items stored in the truck.

The existing truck covering system has exposed some defects during use, such as: 1. When folded and stored, it is impossible to achieve an independent vertical standing posture. One side is supported by a support rod, and the other side needs to be against the truck bed wall; some vehicles do not have a protruding truck bed wall, which will cause one side of the cover to have nowhere to lean against, and thus the cover cannot maintain a standing posture. 2. The car body cover usually uses a fixed frame to connect the car body and the car body cover together. A pressure plate and bolts are set under the frame and the car body cover. The frame and the car body cover are fixed and pressed by the pressure plate and bolts. The pressure plate is flat. Although it can apply a pressing force to the frame, the pressure plate lacks positioning with the frame, resulting in poor pressing effect and unstable cooperation between the frame and the car body cover. 3. The connection between the car body cover and the left and right side panels of the rear compartment is realized through the car body frame mechanism assembly, so as to realize the installation of the car body cover, and the car body cover is formed by a plurality of car body cover plates being movably connected between each other, so that the car body cover can be flipped and folded for loading cargo. However, the existing compartment cover and the compartment frame mechanism components are mostly fixed by means of threads, bayonet pins or rope binding, and the above fixing methods require a certain amount of time to fix the compartment cover and the compartment frame mechanism components to protect against rain or to release the fixation to flip and fold, which is troublesome to use.

### SUMMARY

In order to overcome the above-mentioned deficiencies in the prior art, the present invention provides a truck covering system.

The technical solution of the present invention to solve the technical problem is: a truck covering system, comprising:

A car body frame structure configured to be mounted to a side wall of a truck car body, the car body frame structure having an open space;

A cover system, which is mounted on the carriage frame mechanism, and is composed of one or more panels, and the cover system has at least a flat position state and a standing position state relative to the carriage frame mechanism;

A clamp mechanism, wherein the clamp mechanism can be respectively abutted against the carriage frame mechanism and the cover system, and there is a distance between the clamp mechanism and the cover system;

A fastening mechanism, the fastening mechanism acting on the clamp mechanism and the cover system to increase or decrease the spacing, thereby allowing the cover system to be releasably connected to the carriage frame mechanism;

A latch mechanism is attached to the cover system and is releasably engaged with the carriage frame mechanism.

According to some embodiments of the present disclosure, the following further comprises:

A support element mounted on the carriage frame mechanism;

A supporting element, which is mounted on the capping system and moves along with the capping system;

When the cover system is in a standing position, the abutment element contacts the support element, so that the cover system continues to maintain a standing position relative to the carriage frame mechanism;

When the cover system is in the flat position, the abutment element is disengaged and separated from the support element.

According to some embodiments of the present disclosure, both sides of the abutment element extend outward to form side edges, the side edges surround each other and form a first groove, the support element can be at least partially inserted into the first groove, and the side walls of the support element can contact the side edges so that the support element and the abutment element form a detachable engagement.

According to some embodiments of the present disclosure, a connecting seat is provided on the supporting element, a connecting belt is provided on the covering system, the connecting belt is connected to an elastic buckle, and the elastic buckle can be inserted into the connecting seat, so that the supporting element and the covering system are releasably connected through the connecting belt.

According to some embodiments of the present disclosure, the end surface of the supporting element in contact with the abutting element is a supporting end surface, and the supporting end surface presents an arc shape with a concave middle portion when viewed from a side.

According to some embodiments of the present disclosure, the support element is overall in the shape of a shark fin, and the support end surface is in a triangular shape when viewed from the main side.

According to some embodiments of the present disclosure, at least one of the panels is provided with a support seat;

The carriage frame mechanism is provided with a push rod, which has a hinged end and a movable end. The hinged end is connected to the carriage frame mechanism, and the movable end can be engaged with a support seat to keep the cover system in a standing position.

According to another embodiment, one of the clamp mechanism and the car frame mechanism has a hook, and the other has a hanging slot; the clamp mechanism is operated so that the hook enters the hanging slot, thereby hanging the clamp mechanism on the car frame mechanism.

According to another embodiment, the hook includes an extending portion and a hook portion, the hanging groove includes an opening portion and a hanging portion, the extending portion is correspondingly extended into the opening portion, the hook portion is correspondingly hung into the hanging portion, and the hook portion abuts against the inner wall of the hanging portion to form a limited anti-detachment fit.

According to another embodiment, the clamp mechanism is in a “C” shape as a whole, the clamp mechanism has a first arm on the left side, a second arm on the right side, and a receiving portion is formed between the first arm and the second arm;

The clamp mechanism also has a protrusion, which divides the accommodating part into a first accommodating part and a second accommodating part. The hook and the carriage frame mechanism are correspondingly arranged in the first accommodating part, and the fastening mechanism is correspondingly arranged in the second accommodating part.

According to yet another embodiment, the fastening mechanism comprises a threaded fastener, an abutment seat and a knob;

The clamp mechanism is provided with a through hole, the capping system is provided with a fixing hole, and the threaded fastener passes through the through hole and is screwed into the fixing hole;

The abutment seat is threadedly connected to the upper end of the threaded fastener, and the abutment seat can be fixedly connected to the lower end of the capping system;

The knob is fixedly connected to the lower end of the threaded fastener, and the knob is operated in the tightening direction to drive the threaded fastener to rotate and rise, so that the knob abuts against the lower end of the clamp mechanism, and then the clamp mechanism is close to the capping system.

According to another embodiment, the carriage frame mechanism includes a carriage side rail and a lateral frame, and a sealing member, wherein the carriage side rail is detachably engaged with the lateral frame;

The carriage side rail is provided with a first sealing groove, the lateral frame is provided with a second sealing groove, the lower end of the sealing member has a first sealing portion and a second sealing portion, the first sealing portion is embedded in the first sealing groove, and the second sealing portion is embedded in the second sealing groove;

One or more sealing convex strips are convexly provided on the upper end of the sealing component, and the sealing convex strips can abut against the cover system to form a sealing fit between the carriage frame mechanism and the cover system.

According to another embodiment, the latch mechanism comprises:
a lock housing assembly having a lock pin port;

A lock body assembly is assembled at the lock pin port, and the lock body assembly can move relative to the lock pin port so that the lock body assembly has at least an unlocked position state and a locked position state;

A rope, which is in transmission connection with the lock body assembly;

The unlocking assembly acts on the lock body assembly through a rope; the unlocking assembly includes:

An unlocking transmission element, which is movably disposed in the lock housing assembly, through which the rope passes, and on which one or more columns are provided, which can abut against the rope and pull the rope;

An unlocking operating element connected to the unlocking transmission element, a user controls the unlocking operating element to make the unlocking transmission element move relative to the lock housing assembly, so that the unlocking transmission element acts on the lock body assembly through the rope, so that the lock body assembly switches from the locked position state to the unlocked position state;

when the lock body assembly is in the unlocked position state, the lock body assembly and the carriage frame mechanism are staggered with each other, and the cover system can move freely to switch from the flat position state to the standing position state, at which time the release position is open;

The locking assembly acts on the lock body assembly so that the lock body assembly always has a movement tendency to switch from the unlocked position state to the locked position state; when the lock body assembly is in the locked position state, the lock body assembly forms a limiting cooperation with the carriage frame mechanism to limit the movement of the covering system and keep it in the flat position state, at which time the covering system continues to cover the open space.

According to another embodiment, the unlocking transmission element comprises two of the cylinders, and the unlocking transmission element is disc-shaped, and the two cylinders are arranged in a non-mirror-symmetrical manner relative to the rope, so that the two cylinders are staggered with respect to each other along the initial direction of the rope and form a channel, and the rope is at least partially passed through the channel.

According to another embodiment, the lock housing assembly has two lock pin ports, and each lock pin port is provided with one of the lock body assemblies;

The rope is an integrated rope, and one end of the rope is connected to one of the lock body components, and the other end of the rope is connected to another lock body component.

According to another embodiment, the unlocking transmission element includes a first plate and a second plate, and the column is fixed between the first plate and the second plate;

The first disk body is connected to the unlocking operating element;

The lock housing assembly has a receiving groove, and the second disk body is movably arranged in the receiving groove.

According to another embodiment, a limiting area is provided on the groove wall of the accommodating groove, a guide block is protruding from the second disk body, the guide block extends into the limiting area, and the guide block can move along the limiting area.

According to another embodiment, the lock body assembly comprises: a lock pin housing having a through hole, and a lock pin body movably disposed in the through hole, wherein the lock pin housing is fixed in the lock housing assembly;

One end of the lock pin body is a locking end, and the other end is a linkage end, the linkage end forms a transmission connection with the rope, and the locking assembly acts on the lock pin body so that the lock body assembly always has a movement tendency to switch from an unlocked position state to a locked position state;

The rear edge of the lock pin shell is bent inward to form a stopper, and the lock pin body includes a lock pin block and a lock pin pull rod connected to each other, and the lock pin pull rod is connected to the rope;

The locking component is a spring, which is sleeved on the lock core pull rod and abuts between the stop portion and the lock pin block.

According to another embodiment, the lock housing assembly includes a lock pin base, an unlocking housing kit and a rope cover body which are sequentially arranged from the outside to the inside;

The lock body assembly is located in the lock pin base;

The unlocking transmission element is located in the unlocking housing kit, and the unlocking operating element at least partially extends out of the unlocking housing kit;

A portion of the rope is located in the rope cover, and another portion passes through the unlocking housing kit and enters the locking pin base.

According to another embodiment, the unlocking housing kit includes an unlocking housing base and an unlocking housing cover;

The unlocking housing base and the unlocking housing cover are assembled with each other to form an inner cavity, and the unlocking transmission element is arranged in the inner cavity;

The unlocking shell cover plate extends toward one side of the lock pin base to form a lock pin cover body. The lock pin base has an upper end opening, and the lock pin cover body covers the upper end opening.

the present invention are:

1. With the aid of the abutting and matching relationship between the abutting element and the supporting element, when the covering system is in the standing position, the carriage frame mechanism can indirectly provide good supporting force to the covering system to resist possible tipping force, so that the covering system can be continuously, stably and reliably maintained in the standing position.

Second, it has the structural technical features of hooks and hanging slots. With the help of the coordinated use of hooks and hanging slots, the pre-positioning function of the clamp mechanism and the car frame mechanism can be realized to offset the falling force, that is, it is not necessary to drag the clamp mechanism with hands or tools, and the clamp mechanism and the car frame mechanism will not be separated, so that it is convenient for users to operate the fastening mechanism. At the same time, before operating the fastening mechanism, the user can first adjust the relative position relationship between the clamp mechanism and the car frame mechanism to improve the position accuracy and assembly accuracy between the two.

3. An unlocking transmission element with a column is used, which realizes power transmission with the rope through contact. A single unlocking transmission element can realize the unlocking operation of multiple lock body components through a single rope, which can effectively prevent slippage between the rope and the column, and form multi-point contact to balance the force, thereby ensuring the stability of the transmission. During the non-unlocking operation, the unlocking component does not apply force to the rope, that is, the rope is in a straight and naturally relaxed state, thereby greatly reducing the product material fatigue of the rope, so as to extend the service life of the rope with normal working effect. In addition, during the unlocking rotation process of the unlocking transmission element, one of the columns exerts force on the rope in the inner right direction, and the other column exerts force on the rope in the inner left direction, that is, the forces on the left and right directions of the rope offset each other, forming a double inward winding force, so that the effect of winding and collecting the rope is more stable and reliable, completely eliminating the slippage phenomenon, and ensuring that the unlocking action is consistent and accurate.

### BRIEF DESCRIPTION OF THE DRAWINGS

FIG. 1 is a schematic diagram of a truck having a truck covering system according to various embodiments.

FIG. 2 is a schematic diagram of the structure of the second embodiment in a standing position and a partial enlarged diagram.

FIG. 3 is a schematic structural diagram of the second embodiment in a standing position at another angle.

FIG. 4 is a partial structural cross-sectional view of the second embodiment in a standing position.

FIG. 5 is a schematic diagram of the structure of the second embodiment in a flat position and a partial enlarged diagram.

FIG. 6 is a cross-sectional view of the local structure of the second embodiment in a flat position.

FIG. 7 is an exploded schematic diagram of a local structure in the second embodiment.

FIG. 8 is a schematic diagram of the structure of the support element in the second embodiment from a side perspective.

FIG. 9 is a schematic structural diagram of the support element in the second embodiment from a main viewing angle.

FIG. 10 is a schematic diagram of the bottom structure of the supporting element in the second embodiment.

FIG. 11 is a schematic structural diagram of the abutting element in the second embodiment.

FIG. 12 is a schematic diagram of the structure in which the cover system and the carriage frame mechanism are clamped to each other in the third embodiment.

FIG. 13 is a schematic diagram of the structure of the cover system and the carriage frame mechanism releasing each other (the clamp mechanism is not disassembled) in the third embodiment.

FIG. 14 is a schematic diagram of the structure of the cover system and the carriage frame mechanism being released from each other (the clamp mechanism being disassembled) in the third embodiment.

FIG. 15 is an exploded view of the third embodiment.

FIG. 16 is a cross-sectional view of the third embodiment.

FIG. 17 is a schematic diagram of the structure of the clamp mechanism in the third embodiment.

FIG. 18 is a schematic diagram of the structure of the carriage side rails in Example 3.

FIG. 19 is a schematic diagram of the structure of the lateral frame in the third embodiment.

FIG. 20 is a schematic diagram of the structure of the sealing component in the third embodiment.

FIG. 21 is a schematic diagram of the local structure when the hook is extended into the hanging groove in the third embodiment.

FIG. 22 is a schematic diagram of the local structure when the hook is out of the hanging groove in the third embodiment.

FIG. 23 is a schematic diagram of the drainage mechanism in the third embodiment.

FIG. 24 is a schematic diagram of the structure of the fourth embodiment.

FIG. 25 is a centering cross-sectional view of the fourth embodiment.

FIG. 26 is an enlarged schematic diagram of portion A in FIG. 25.

FIG. 27 is an exploded view of the fourth embodiment.

FIG. 28 is a schematic diagram and a partially enlarged diagram of the fourth embodiment in the locked position.

FIG. 29 is a schematic diagram and a partially enlarged diagram of the fourth embodiment in the unlocked position.

FIG. 30 is a schematic diagram of the positional relationship between the unlocking assembly and the rope in the locked position state in the fourth embodiment.

FIG. 31 is a schematic diagram of the positional relationship between the unlocking assembly and the rope in the unlocked position state in the fourth embodiment.

FIG. 32 is a schematic diagram of the partial coordination of the unlocking assembly, the lock body assembly and the rope in the fourth embodiment.

FIG. 33 is an exploded schematic diagram of the lock body assembly in the fourth embodiment.

FIG. 34 is a schematic diagram of the partial structure of the latch mechanism in Example 4.

FIG. 35 is a schematic diagram showing a partial structural comparison of the latch mechanism in the truck covering system in the fourth embodiment switching from a locked position to an unlocked position.

FIG. 36 is a schematic diagram of the structure of the truck covering system in the fourth embodiment in a flat position.

FIG. 37 is a schematic diagram of the structure of the truck covering system in the fourth embodiment in a standing position.

In the figure: 11, cover system; 1101, panel; 11a, flat position; 11b, standing position; 1102, support seat; 12, carriage frame mechanism; 1201, top rod; 12011, hinged end; 12012, movable end; 13, support element; 1301, support end surface; 1301a, arc shape; 1301b, triangular shape; 1302, second groove; 1303, mounting groove; 14, abutment element; 1401, side; 1402, first groove; 15, connecting seat; 16, connecting belt; 17, elastic buckle; 21a, spacing; 211, fixing hole; 221, carriage side rail; 2211, first sealing groove; 2212, plug-in structure; 2213, first vertical side wall; 2214, horizontal end face; 222, lateral frame; 2221, hanging groove; 22211, opening part; 22212, hanging part; 2222, second sealing groove; 2223, second vertical side wall; 2224, toothed structure; 223, sealing member; 2231, first sealing part; 2232, second sealing part; 2233, sealing convex strip; 23, clamp mechanism; 231, hook; 2311, insertion portion; 2312, hook portion; 232, first arm; 233, second arm; 2331, straight end surface; 234, convex block; 23a, first accommodating portion; 23b, second accommodating portion; 235, through hole; 24, fastening mechanism; 241, threaded fastener; 242, abutment seat; 243, knob; 25, drainage mechanism; 251, drainage frame; 252, sewer pipe; 253, water flow channel; 3, latch mechanism; 31, lock housing assembly; 311, lock pin base; 3111, upper opening; 312, unlocking housing kit; 3121, unlocking housing base; 31211, receiving groove; 31212, limiting area; 3122, unlocking housing cover; 31221, lock pin cover; 3123, inner cavity; 313, rope cover; 3111, lock pin port; 32, lock body assembly; 32a, unlocking position state; 32b, locking position state; 321, lock pin housing; 3211, through hole; 3212, stopper; 322, lock pin body; 322a, locking end; 322b, linkage end; 3221, lock pin block; 3222, locking pin pull rod; 33, rope; 33a, channel; 34, locking assembly; 35, unlocking assembly; 351, unlocking transmission element; 3511, column; 35111, right side wall; 35112, left side wall; 3512, first disk; 3513, second disk; 35131, guide block; 35132, circular shaft; 3514, support rib; 352, unlocking operating element; 3521, quadrilateral prism; 35a, inner right direction; 35b, inner left direction; 36, in the same straight line direction; 3711, open space; 4, pickup truck; 41, truck compartment.

### DETAILED DESCRIPTION

The following will be combined with the drawings in the embodiments of the present invention to clearly and completely describe the technical solutions in the embodiments of the present invention. Obviously, the described embodiments are only part of the embodiments of the present invention, not all of the embodiments. Based on the embodiments of the present invention, all other embodiments obtained by ordinary technicians in this field without creative work are within the scope of protection of the present invention.

### Embodiment 1

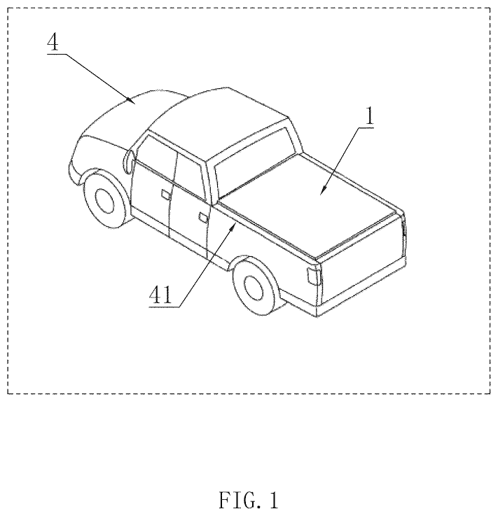

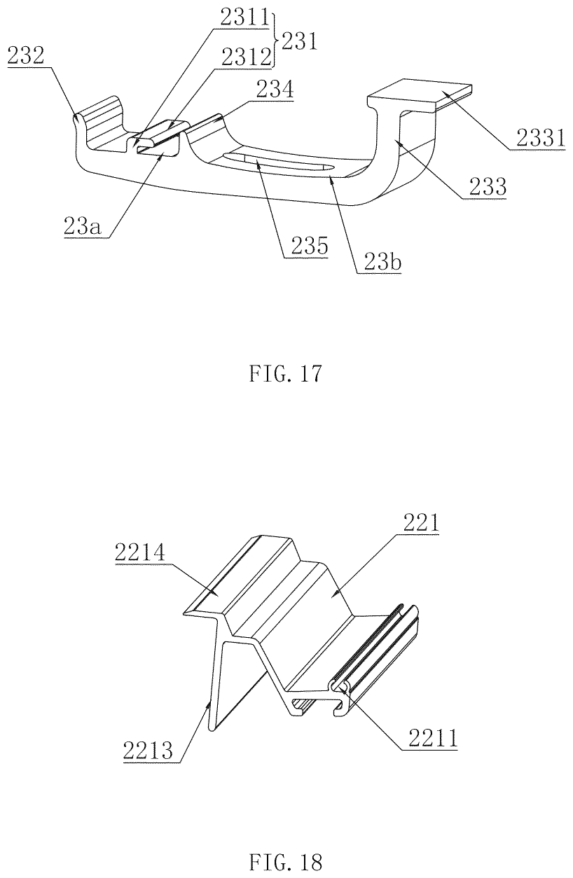

FIGS. 1 to 3, a truck covering system includes: a car frame mechanism 12, which is configured to be mounted on the side wall of a truck car body 41, and the car frame mechanism 12 has an open space 3711; a cover system 11, which is mounted on the car frame mechanism 12, and the cover system 11 is composed of one or more panels 1101. Referring to FIGS. 36 to 17, the cover system 11 has at least a flat position state 11a and a standing position state 11b relative to the car frame mechanism 12; a clamp mechanism 23, the clamp mechanism 23 can respectively abut against the car frame mechanism 12 and the covering system 11, and there is a distance 21a between the clamp mechanism 23 and the covering system 11; the fastening mechanism 24, the fastening mechanism 24 acts on the clamp mechanism 23 and the covering system 11 to increase or decrease the distance 21a, so that the covering system 11 and the car frame mechanism 12 form a releasable connection; the latch mechanism 3 is attached to the covering system 11, and the latch mechanism 3 and the car frame mechanism 12 form a releasable engagement.

It is worth mentioning that the truck covering system is applied to freight vehicles (such as pickup trucks 4), and the open space 3711 is a rear cargo space that can be used to prevent cargo. The truck covering system switches to the flat position state 11a to cover the rear cargo space and provide effective protection against water, dust, theft, etc.; when cargo needs to be placed or taken out or the cargo is large in size, the truck covering system switches to the standing position state 11b to release the rear cargo space.

### Embodiment 2

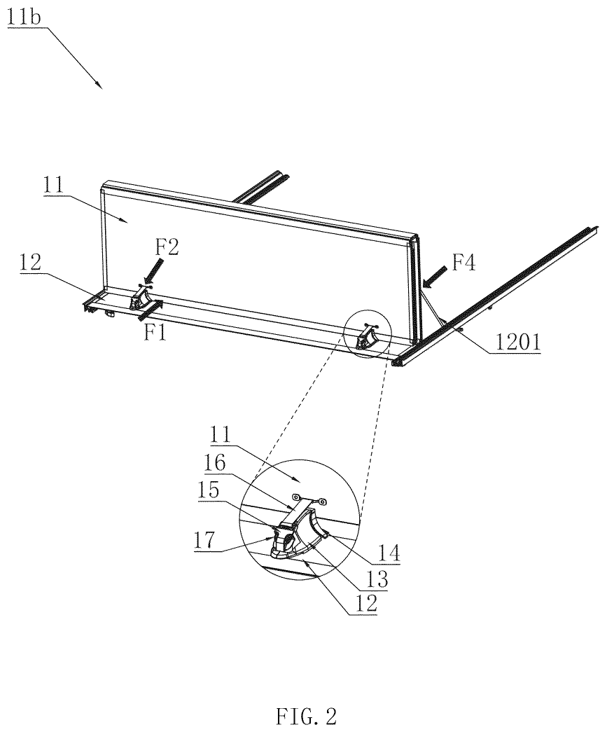

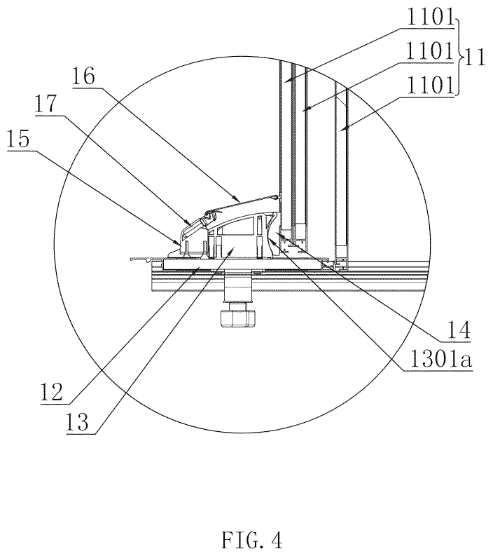

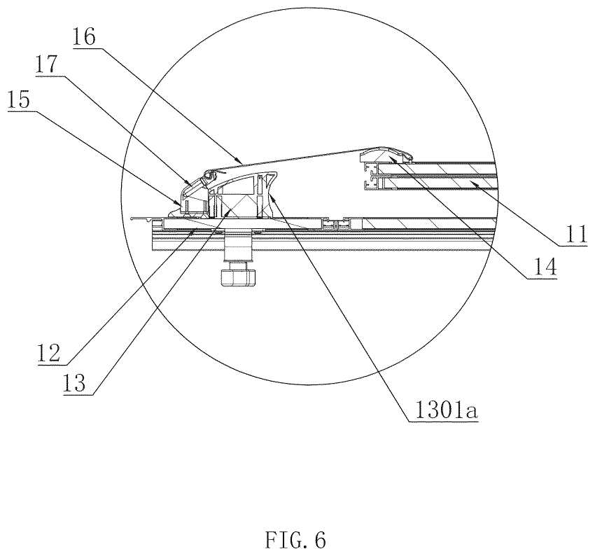

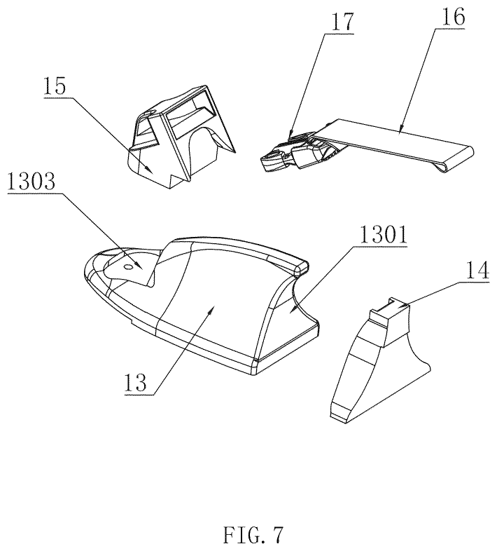

FIGS. 2 to 11, a truck covering system includes:

A covering system 11, which is mounted on the carriage frame mechanism 12, and the covering system 11 is composed of at least one or more panels 1101, and the covering system 11 has at least a lying position state 11a and a standing position state 11b relative to the carriage frame mechanism 12; a supporting element 13, which is mounted on the carriage frame mechanism 12; and a supporting element 14, which is mounted on the covering system 11, and the supporting element 14 moves together with the covering system 11.

The positional relationship and working mechanism of the supporting element 13 and the abutting element 14 are as follows: when the covering system 111 is in the standing position state 11b, the abutting element 14 contacts the supporting element 13, so that the covering system 11 continues to maintain the standing position state 11b relative to the car frame mechanism 12; when the covering system 11 is in the flat position state 11a, the abutting element 14 disengages and separates from the supporting element 13.

In the above, the supporting element 13 forms a force F1 on the covering system 11 through the abutting element 14, and the force direction of the force F1 is opposite to the operating direction when the covering system 11 switches from the flat position state 11a to the standing position state 11b, thereby being able to play an effective anti-tipping role, so that the covering system 11 can stand on the car frame mechanism 12 in a stable and reliable state.

When the abutting element 14 and the supporting element 13 are in abutment, if they are in single-sided contact, a part of them may be displaced when subjected to lateral force, so that the relative position changes and the force cannot be balanced, and thus the standing position state 11b cannot be maintained stably. In order to solve the above-mentioned defects, the further configuration adopted by the present invention is as follows: the two sides of the abutting element 14 extend outward to form side edges 1401, and a first groove 1402 is formed between the side edges 1401, and at least part of the supporting element 13 can be inserted into the first groove 1402, and the side wall of the supporting element 13 can contact the side edges 1401, so that the supporting element 13 and the abutting element 14 are detachably engaged. Through the setting of the first groove 1402, a tighter matching space is provided for the abutting element 14, and at the same time, a lateral auxiliary supporting force is provided when the side edges 1401 contact the supporting element 13, so that there are multiple contact surfaces in different directions between the supporting element and the abutting element 14, so as to realize multi-directional support, and thus make the matching more stable and reliable.

FIGS. 2 to 5, a support structure solution of the capping system 11 is provided, which is as follows: the support element 13 is provided with a connection seat 15, the capping system 11 is provided with a connection belt 16, the connection belt 16 is connected with an elastic buckle 17, and the elastic buckle 17 can be inserted into the connection seat 15, so that the support element 13 is releasably connected to the capping system 11 through the connection belt 16. Preferably, the connection belt 16 is a retractable belt with adjustable length.

During the insertion process, the elastic buckle 17 shrinks due to the squeezing force of the inner wall of the connecting seat 15, and can enter into the connecting seat 15 after shrinking. After entering into place, the squeezing force is eliminated and the elastic buckle 17 recovers by itself, thereby forming an anti-detachment fit; when it needs to be pulled out, the user pinches the elastic buckle 17 hard to make the elastic buckle 17 shrink under force, and then pulls the elastic buckle 17 backwards to separate it from the connecting seat 15, thereby realizing the separation operation of the two.

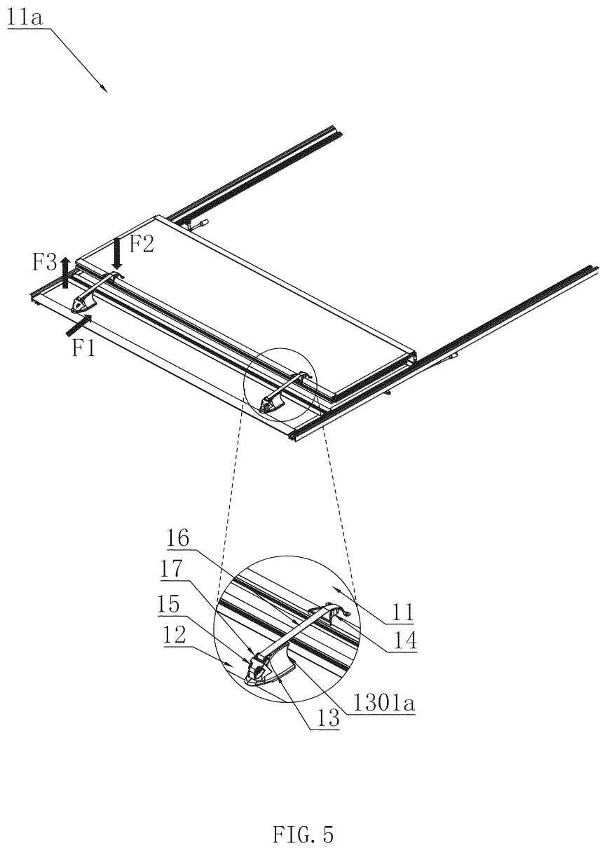

The elastic buckle 17 and the connecting seat 15 can play a connecting and supporting role in both the flat position state 11a and the standing position state 11b, specifically: referring to FIGS. 2 and 5, when in the standing position state 11b, the retractable belt is tightened and the length is shortened. At this time, the supporting element 13 forms a force F2 on the covering system 11 through the connecting belt 16, and the force F1 and the force F2 are opposite in direction to each other to offset part of the force, so that the covering system 11 can be stably maintained in the standing position state 11b; when in the flat position state 11a (the panel 1101 can be partially unfolded or fully unfolded), the retractable belt is released and the length is lengthened. At this time, the force F2 formed can make the covering system 11 resist the up and down force F3 during bumpy driving to prevent the panel 1101 from being continuously squeezed up and down, so that it can be stably maintained in the flat position state 11a.

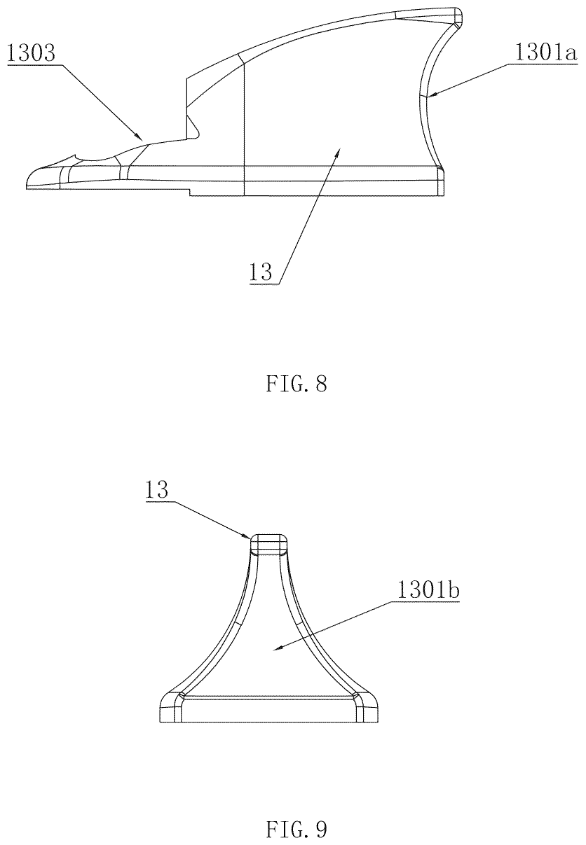

Regarding the preferred solution of the structure of the supporting element itself, specifically: Referring to FIG. 8, the end surface of the supporting element 13 in contact with the abutting element 14 is the supporting end surface 1301, and the supporting end surface 1301 presents an arc shape 1301a with a concave middle portion in a lateral viewing angle. The supporting end surface 1301 with a specific shape of the arc shape 1301a has a larger contact area at the same height and has rotational symmetry, so that when subjected to force, the stress can be dispersed more evenly, and has higher stability, thereby withstanding a greater external force.

Further preferably, referring to FIG. 9, the support element 13 is in the shape of a shark fin, and the support end surface 1301 is in a triangular shape 1301b in the main side view. Since the application of the cover system 11 involved in the present invention in vehicles (especially freight vehicles) is one of the main use scenarios, the overall structure of the shark fin can effectively guide the air and reduce the wind resistance; at the same time, the shark fin shape is small at the top and large at the bottom, so that the support element 13 itself has better structural strength.

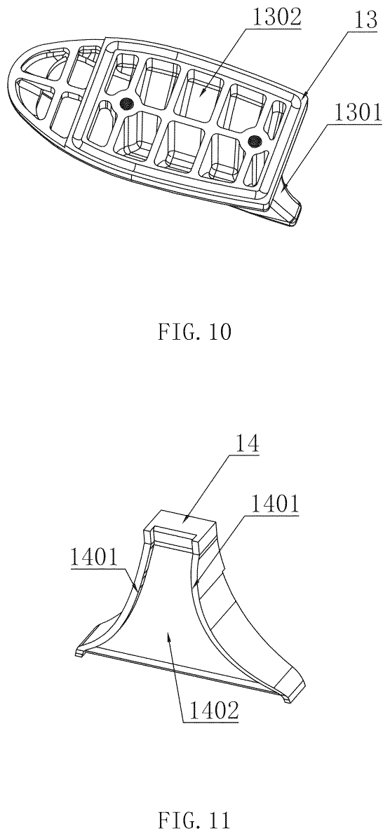

Another preferred configuration, referring to FIG. 10, is that the lower end of the support element 13 is provided with at least one or more second grooves 1302 upwardly. The configuration of the second grooves 1302, on the one hand, can effectively reduce the use of raw materials while ensuring the structural strength, thereby reducing the production cost; on the other hand, when subjected to force, the support element can be slightly deformed and self-recovered due to the presence of the second grooves 1302, thereby being able to better resist external force impacts.

Regarding the preferred installation method of components such as the support element 13 and the connecting seat 15, specifically: referring to FIGS. 2 to 7, the upper end of the support element 13 is also provided with a mounting groove 1303, the connecting seat 15 is at least partially embedded in the mounting groove 1303, and the connecting seat 15 is fixed to the support element 13 by a first fastener; the support element 13 is fixed to the car frame mechanism 12 by a second fastener.

The first fastener and the second fastener are not shown in the drawings, and preferably fasteners in the form of screws, bolts, etc. may be used.

In addition, the connecting seat 15 and the supporting element 13 may also be integrally formed by injection molding or other processes, which is not particularly limited herein.

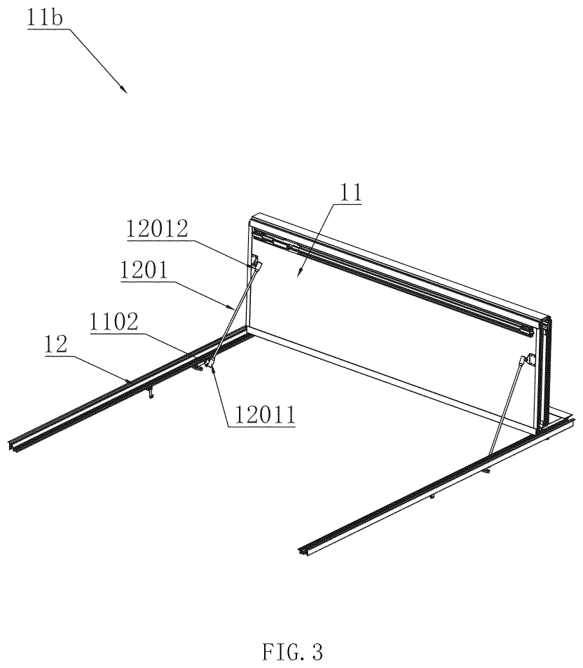

Another optional supporting structure is as follows: referring to FIGS. 2 to 3, at least one of the panels 1101 is provided with a supporting seat 1102; the carriage frame mechanism 12 is provided with a top rod 1201, and the top rod 1201 has a hinged end 12011 and a movable end 12012, the hinged end 12011 is connected to the carriage frame mechanism 12, and the movable end 12012 can engage with the supporting seat 1102 to keep the covering system 11 in the standing position state 11b.

1. Standing position state 11b: Referring to FIGS. 2 to 3, the two ends of the top rod 1201 are respectively supported and connected between one of the panels 1101 and the car frame mechanism 12, and a part of the panel 1101 is folded and stored between the two outermost panels 1101. The top rod 1201 forms a force F4 on the covering system 11, and the force F4 is opposite to the force F1 and offsets each other, so that the covering system 11 is continuously and stably maintained in the standing position state 11b.

2. Flat position state 11a: Referring to FIGS. 5 and 36, the top rod 1201 is stored in the car frame mechanism 12, and multiple panels 1101 are connected end to end and laid flat on the car frame mechanism 12 in sequence to cover the car frame mechanism 12 and protect the items placed in the car frame mechanism 12.

### Embodiment 3

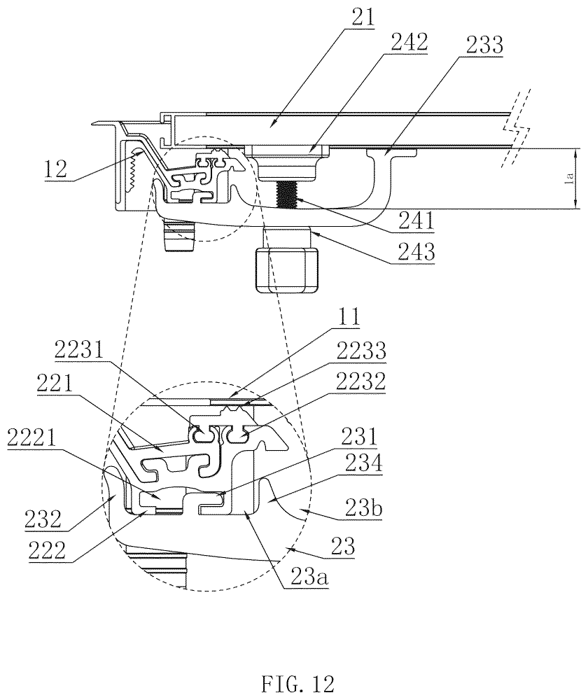

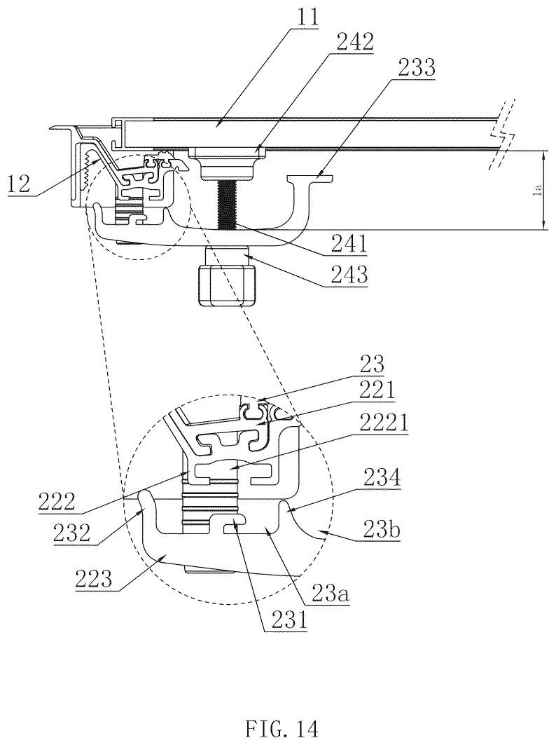

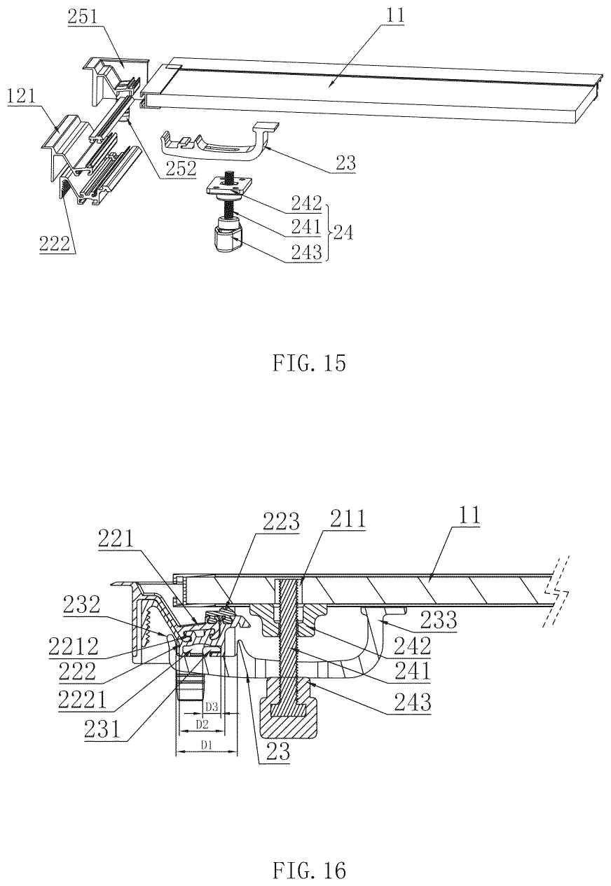

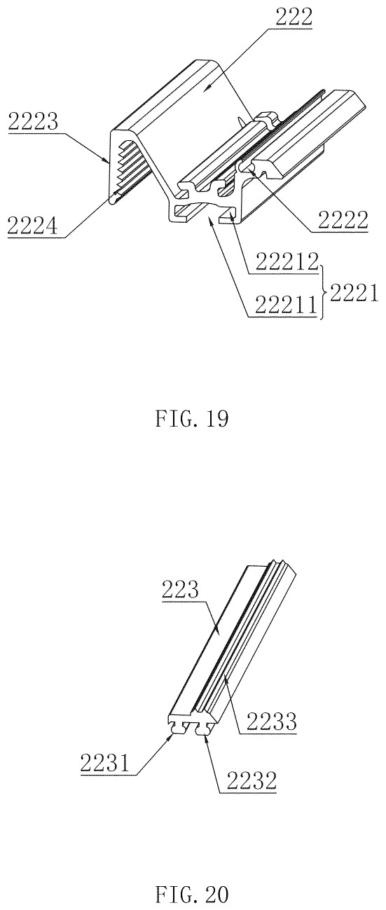

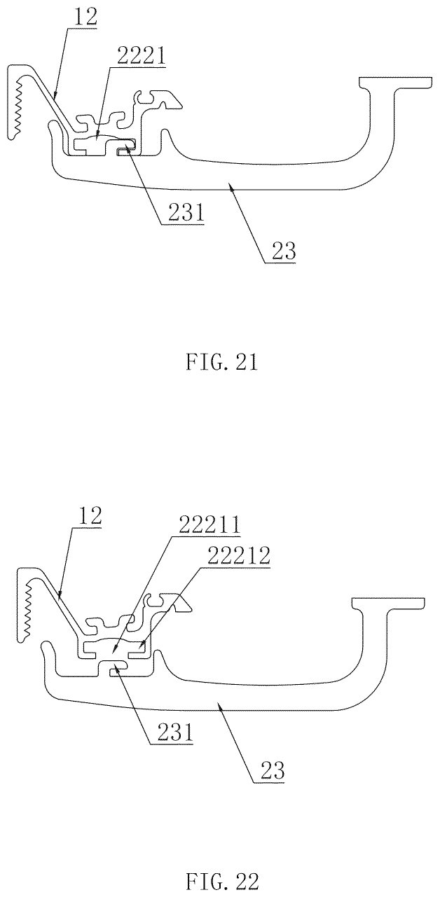

FIGS. 12 to 23, one of the clamp mechanism 23 and the carriage frame mechanism 12 has a hook 231, and the other has a hanging groove 2221; the clamp mechanism 23 is operated so that the hook 231 enters the hanging groove 2221, thereby hanging the clamp mechanism 23 on the carriage frame mechanism 12.

Taking the application of the truck covering system to the truck bed as an example, its usage is as follows: in the initial situation, the spacing 21a is large, so the covering system 11 and the car frame mechanism 12 are in an unclamped state. At this time, the user assembles the car frame mechanism 12 to the corresponding position of the truck bed, and then aligns the hook 231 with the hanging groove 2221 and inserts it, so that the clamp mechanism 23 and the car frame mechanism 12 are connected to each other, and after adjusting the relative position of the clamp mechanism 23 and the car frame mechanism 12, it plays a pre-positioning role, and then operates the fastening mechanism 24 to reduce the spacing 21a, and under the action of the fastening mechanism 24 and the clamp mechanism 23, the covering system 11 and the car frame mechanism 12 are clamped to each other.

It should be noted that, unlike the prior art, the present invention has the structural technical features of a hook 231 and a hanging groove 2221. By means of the coordinated use of the hook 231 and the hanging groove 2221, the pre-positioning function of the clamp mechanism 23 and the carriage frame mechanism 12 can be realized to offset the falling force, that is, it is not necessary to drag the clamp mechanism 23 by hand or tools, and the clamp mechanism 23 and the carriage frame mechanism 12 will not be separated, so that it is convenient for users to operate the fastening mechanism 24. At the same time, before operating the fastening mechanism 24, the user can first adjust the relative position relationship between the clamp mechanism 23 and the carriage frame mechanism 12 to improve the position accuracy and assembly accuracy between the two.

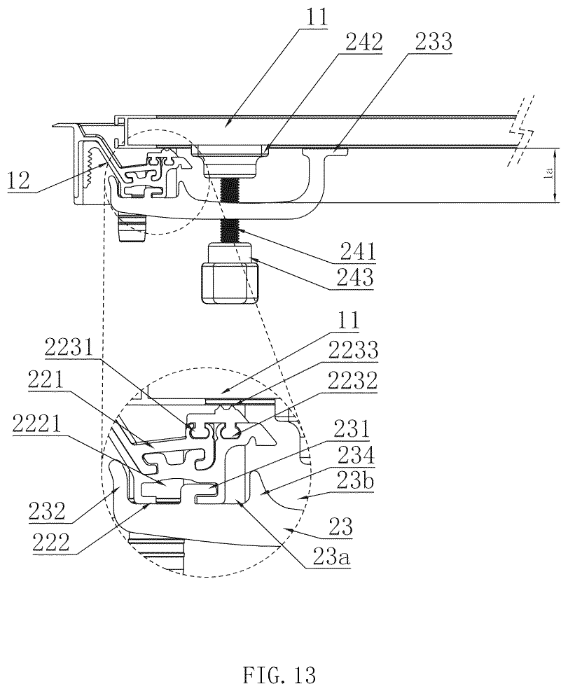

Referring to FIG. 12 and FIG. 13, a more preferred solution is provided for each component, as follows:

1. Hook 231: It includes an insertion portion 2311 and a hook portion 2312. The hanging groove 2221 includes an opening portion 22211 and a hanging portion 22212. The insertion portion 2311 is correspondingly inserted into the opening portion 22211, and the hook portion 2312 is correspondingly hung in the hanging portion 22212, and the hook portion 2312 is abutted against the inner wall of the hanging portion 22212 to form a limited anti-detachment fit.

The opening portion 22211 is provided to facilitate the hook 231 to enter or escape from the hanging groove 2221. It is worth mentioning that the lateral dimension of the opening portion 22211 is greater than or equal to the lateral dimension of the hook portion 2312 to provide sufficient passing space, so that the hook portion 2312 can smoothly pass through the opening portion 22211 and enter the hanging portion 22212.

2. Clamping mechanism 23: Referring to FIG. 17, preferably, the whole is in a “C” shape. The clamping mechanism 23 has a first arm 232 on the left side and a second arm 233 on the right side, and a receiving portion is formed between the first arm 232 and the second arm 233;

Furthermore, the clamp mechanism 23 also has a protrusion 234, which divides the accommodation part into a first accommodation part 23a and a second accommodation part 23b, thereby realizing spatial partitioning to better realize the corresponding functions. More specifically, the hook 231 and the carriage frame mechanism 12 are correspondingly arranged in the first accommodation part 23a, and the fastening mechanism 24 is correspondingly arranged in the second accommodation part 23b.

It is worth mentioning that the upper end of the second arm 233 is formed with a straight end surface 2331, which can abut against the lower end of the cover system 11 and has a larger contact area to form a second cover support point, so that the clamp mechanism 23 can provide a more reliable support effect on the cover system 11. On the other hand, the lower end of the carriage frame mechanism 12 can abut against the bottom surface of the first accommodating portion 23a to form a frame support point, so that the clamp mechanism 23 can provide a more reliable support effect on the carriage frame mechanism 12.

Referring to FIG. 16, preferably, the lateral dimension of the first accommodating portion 23a is D1, the lateral dimension of the car frame mechanism 12 entering into the first accommodating portion 23a is D2, and the lateral dimension of the hook 231 is D3, and D1>D2+D3 is satisfied to eliminate structural interference, so that the hook 231 can enter and exit the hanging groove 2221 normally.

3. Fastening mechanism 24: Referring to FIGS. 12 to 16, it includes a threaded fastener 241, an abutment seat 242 and a knob 243.

The clamp mechanism 23 is provided with a through hole 235, the capping system 11 is provided with a fixing hole 211, the threaded fastener 241 passes through the through hole 235 and is screwed into the fixing hole 211, and after the threaded fastener 241 is screwed into the fixing hole 211, the fastening mechanism 24 and the capping system 11 form a fixed fit. Preferably, the size of the through hole 235 is larger than the size of the threaded fastener 241, so as to facilitate adjustment of the position of the threaded fastener 241.

The abutment seat 242 is threadedly connected to the upper end of the threaded fastener 241, and the abutment seat 242 can be fixedly connected to the lower end of the capping system 11 to form a third cover support point. A larger contact area is formed between the abutment seat 242 and the capping system 11, so that the abutment seat 242 (fastening mechanism 24) provides a closer support effect to the capping system 11.

The knob 243 is fixedly connected to the lower end of the threaded fastener 241, and the knob 243 is operated in the tightening direction to drive the threaded fastener 241 to rotate and rise, so that the knob 243 abuts against the lower end of the clamp mechanism 23, and then the clamp mechanism 23 approaches the cover system 11. For example: when the knob 243 is operated in the forward direction, the knob 243 abuts against the clamp mechanism 23 and the clamp mechanism 23 approaches the cover system 11, reducing the distance 21a, so that the cover system 11 and the carriage frame mechanism 12 are clamped together; when the knob 243 is operated in the reverse direction, the knob 243 moves away from the cover system 11, and the clamp mechanism 23 also moves away from the cover system 11 after losing the force of the knob 243 and under the action of gravity, increasing the distance 21a, so that the cover system 11 and the carriage frame mechanism 12 are released from each other.

4. Carriage frame mechanism 12: Referring to FIGS. 12 to 22, it includes a carriage side rail 221, a lateral frame 222, and a sealing member 223. The carriage side rail 221 and the lateral frame 222 are detachably connected.

The carriage side rail 221 is provided with a first sealing groove 2211, the lateral frame 222 is provided with a second sealing groove 2222, and the lower end of the sealing member 223 has a first sealing portion 2231 and a second sealing portion 2232. The first sealing portion 2231 is embedded in the first sealing groove 2211, so that a sealing fit is formed between the sealing member 223 and the first frame; the second sealing portion 2232 is embedded in the second sealing groove 2222, so that a sealing fit is formed between the sealing member 223 and the second frame; the upper end of the sealing member 223 is provided with one or more sealing convex strips 2233, and the sealing convex strips 2233 can abut against the cover system 11, so that a sealing fit is formed between the carriage frame mechanism 12 and the cover system 11, and the abutment between the sealing member 223 and the cover system 11 forms a first cover plate support point.

The first sealing portion 2231, the second sealing portion 2232 and the sealing convex strip 2233 form a sealed fit between the cover system 11 and the carriage frame mechanism 12. More specifically, the sealing isolation between the inside and the outside is achieved to prevent rainwater, impurities, etc. from entering the inside space.

Preferably, the carriage side rail 221 is installed on the upper end of the lateral frame 222 through a plug-in structure 2212. Of course, the carriage side rail 221 is connected to the lateral frame 222 by other structural methods such as a magnetic structure and a buckle structure, which is not particularly limited here.

Furthermore, the outer side of the carriage side rail 221 has a first vertical side wall 2213, and the first vertical side wall 2213 can be abutted against the side wall of the truck bucket. In addition, the upper end of the first vertical side wall 2213 extends outward to form a straight horizontal end surface 2214, and the horizontal end surface 2214 can be abutted against the upper end surface of the truck bucket. Through the cooperation between the first vertical side wall 2213, the horizontal end surface 2214 and the truck bucket, the carriage frame mechanism 12 can be abutted against the truck bucket.

On the other hand, the outer side of the lateral frame 222 has a second vertical side wall 2223, the second vertical side wall 2223 is located on the inner side of the first vertical side wall 2213, and the second vertical side wall 2223 has a tooth structure 2224. With the help of a pressure plate mechanism (refer to patent document CN213199431U), the pressure plate mechanism is clamped between the tooth structure 2224 and the side wall of the truck bucket to fix the car frame mechanism 12 and the side wall of the truck bucket together. In addition, the provision of the tooth structure 2224 can provide greater friction, making the connection between the pressure plate mechanism and the second vertical side wall 2223 more stable and reliable.

Taking the truck bed as an example, the actual use environment is mostly outdoors. Therefore, once it rains, rainwater will fall onto the cover system 11 and the car frame mechanism 12. If it is not discharged in time, the rainwater will accumulate and easily enter the interior of the truck bed, causing the items stored inside to get wet.

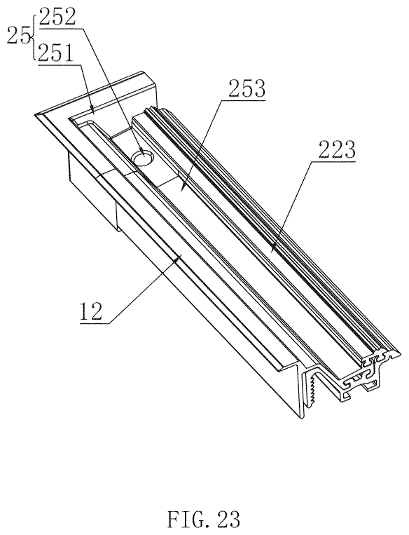

In order to enrich the use function and deal with rainy weather, based on the structure of any of the above embodiments, referring to FIG. 23, a drainage mechanism 25 is also included, and the drainage mechanism 25 includes a drainage frame 251 and a sewer pipe 252; the drainage frame 251 is connected to any end of the carriage frame mechanism 12, and a water flow channel 33a253 is formed between the drainage frame 251 and the carriage frame mechanism 12, and the water flow channel 33a253 is located outside the sealing member 223, and the water flow channel 33a253 and the sewer pipe 252 are mutually conductive. When in use, rainwater will fall onto the cover system 11 and the carriage frame mechanism 12, and then the rainwater will flow into the sewer pipe 252 along the water flow channel 33a253, and be discharged to the outside through the sewer pipe 252, so as to drain water in time, prevent rainwater from accumulating, and prevent rainwater from entering the inner side of the sealing member 223, so as to keep the inside of the truck bucket always in a dry environment.

### Embodiment 4

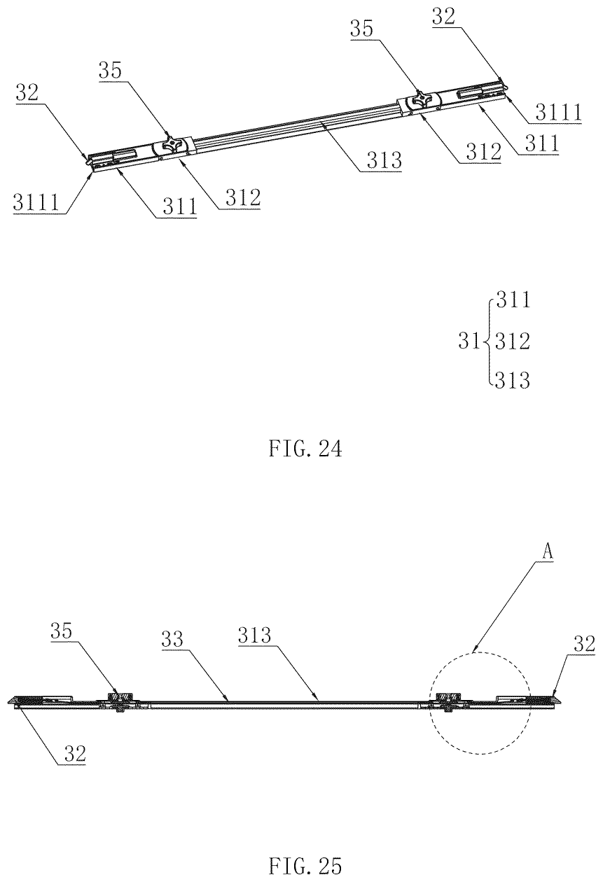

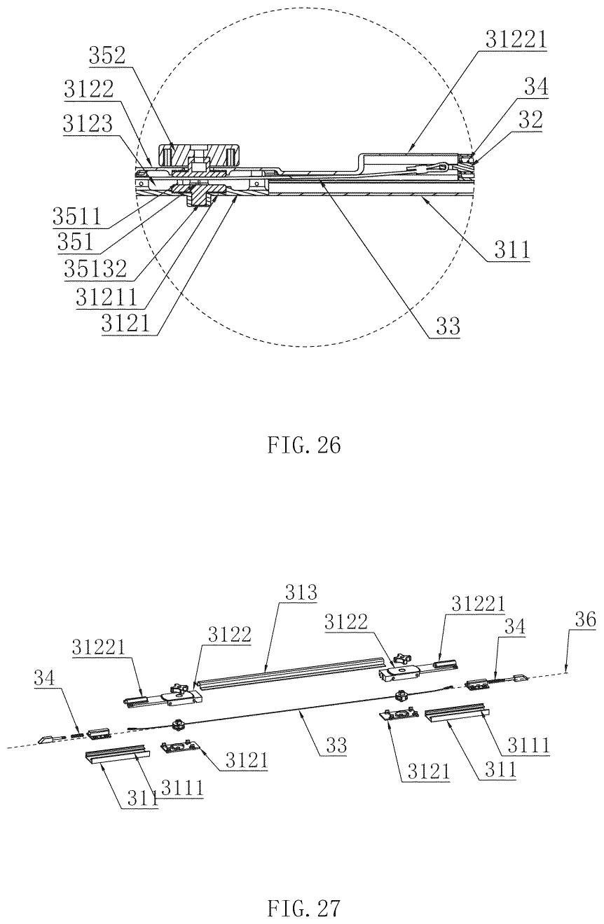

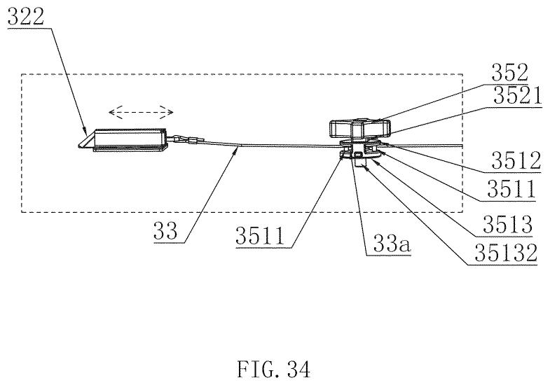

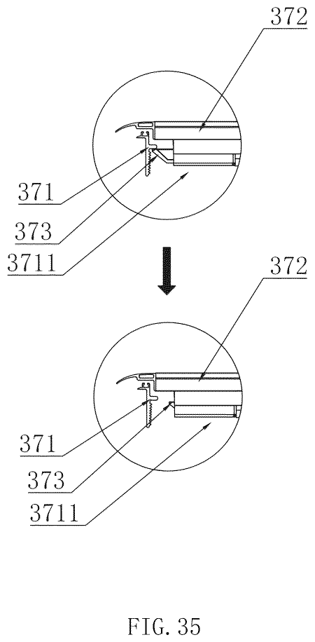

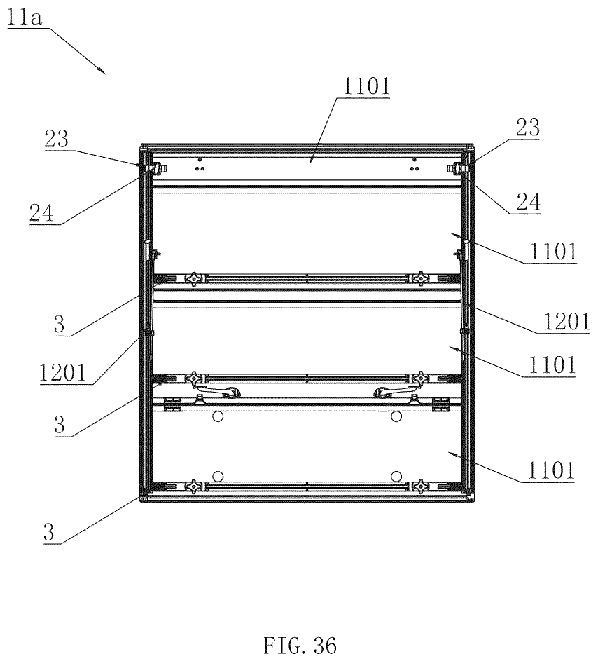

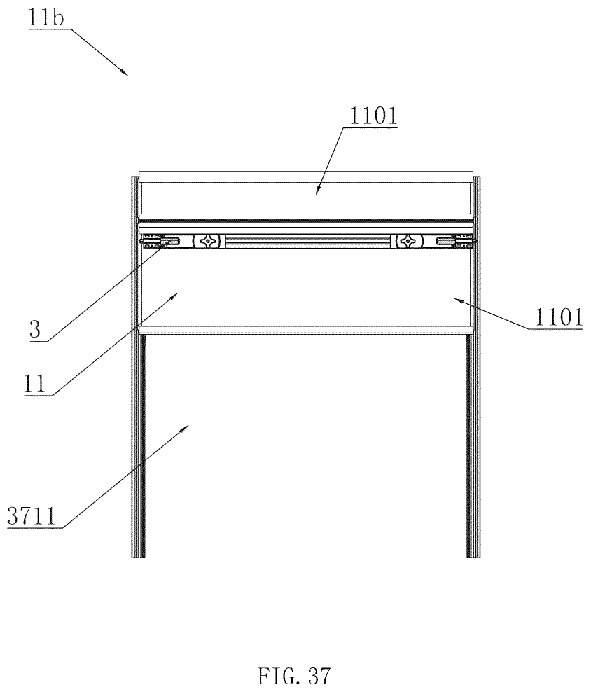

FIGS. 24 to 37, the latch mechanism 3 includes: a lock housing assembly 31 having a lock pin port 3111; a lock body assembly 32 assembled at the lock pin port 3111, the lock body assembly 32 being movable relative to the lock pin port 3111 so that the lock body assembly 32 has at least an unlocked position state 32a and a locked position state 32b; and a rope 33 drivingly connected to the lock body assembly 32.

It is worth mentioning that the unlocking component 35 is different from the structural solution of the prior art. Referring to FIG. 27, the unlocking component 35 specifically includes:

An unlocking transmission element 351 is movably disposed in the lock housing assembly 31. The rope 33 passes through the unlocking transmission element 351. The unlocking transmission element 351 has one or more columns 3511. The columns 3511 can abut against the rope 33 and pull the rope 33.

The unlocking operating element 352 is connected to the unlocking transmission element 351. The user controls the unlocking operating element 352 to make the unlocking transmission element 351 move relative to the lock housing assembly 31, so that the unlocking transmission element 351 acts on the lock body assembly 32 through the rope 33, so that the lock body assembly 32 switches from the locked position state 32b to the unlocked position state 32a; when the lock body assembly 32 is in the unlocked position state 32a, the lock body assembly 32 and the carriage frame mechanism 12 are staggered, and the cover system 11 can move freely to switch from the flat position state 11a to the standing position state 11b, and the release position is open space 3711;

The locking assembly 34 acts on the lock body assembly 32 so that the lock body assembly 32 always has a movement tendency to switch from the unlocked position state 32a to the locked position state 32b; when the lock body assembly 32 is in the locked position state 32b, the lock body assembly 32 forms a limiting cooperation with the car frame mechanism 12 to limit the movement of the covering system 11 and keep it in the flat position state 11a, at which time the covering system 11 continues to cover the open space 3711.

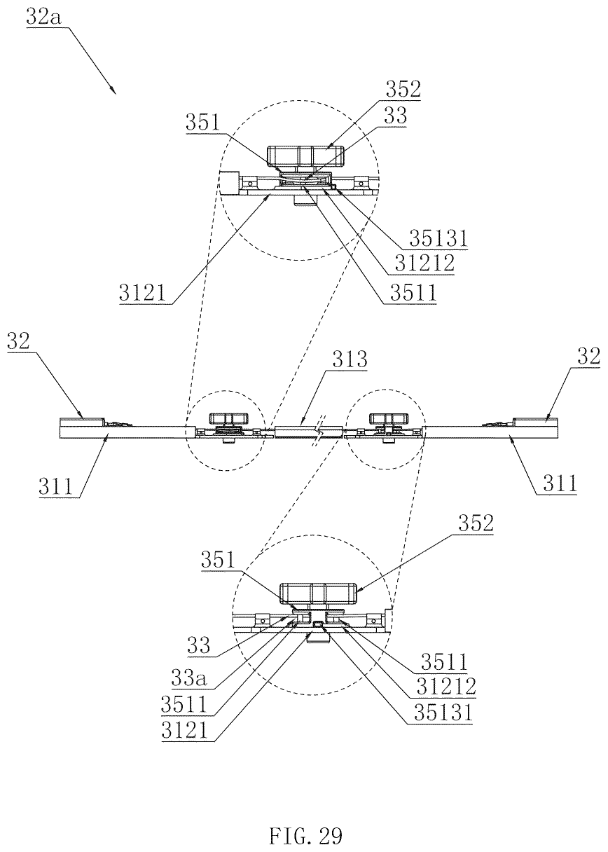

The working principle of the unlocking operation is as follows: referring to FIGS. 29 and 31, the user controls the unlocking operating element 352 to make the unlocking transmission element 351 move (preferably rotate) relative to the lock housing assembly 31, so that the column 3511 on the unlocking transmission element 351 abuts against the rope 33 and transmits power, and the rope 33 then applies the power to the lock body assembly 32, so that the lock body assembly 32 switches from the locked position state 32b to the unlocked position state 32a.

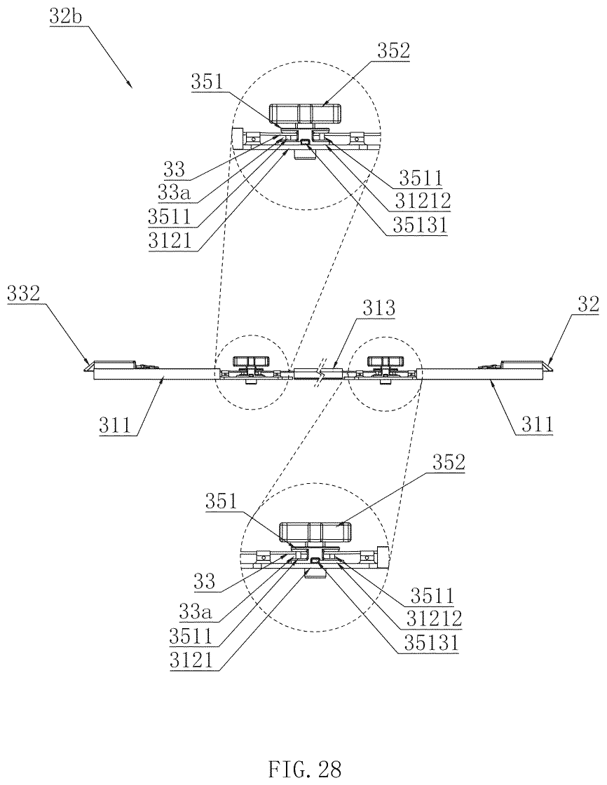

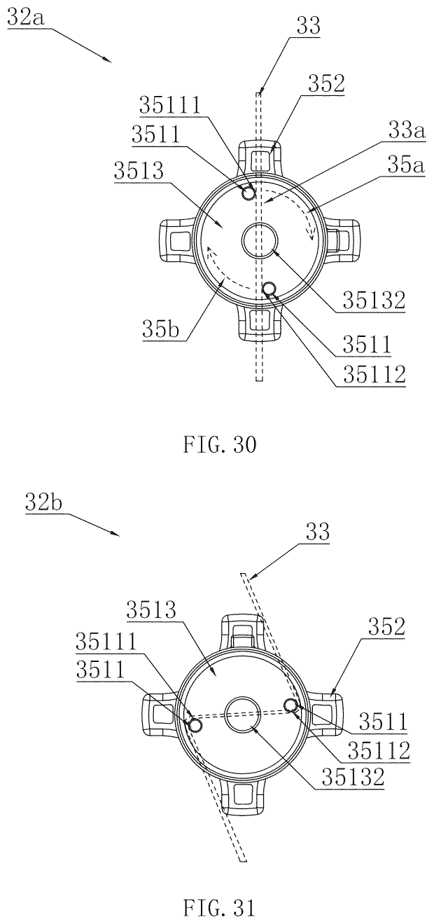

The working principle of the locking operation is as follows: referring to FIGS. 28 and 30, the user releases the unlocking operating element 352, and the lock body assembly 32 removes the external force, so that under the reset force of the locking assembly 34 (the force accumulated during the unlocking process), the lock body assembly 32 switches to the locked position state 32b, and at the same time, the locking assembly 34 also restores the rope 33 and the unlocking assembly 35 to their initial states.

The present invention adopts an unlocking transmission element 351 having a column 3511, which realizes power transmission with the rope 33 by contact, thereby realizing the unlocking operation of the lock body assembly 32. It is worth mentioning that the present invention has many advantages. First, the fixed connection mode is eliminated. Specifically, the rope 33 does not need to be fixedly connected with the unlocking transmission element 351, which optimizes the production process and reduces the difficulty of assembly; second, a single unlocking transmission element 351 can realize the unlocking operation of multiple lock body assemblies 32 through a single rope 33; third, when the unlocking operation is not in progress, the unlocking assembly 35 does not apply force to the rope 33, that is, the rope 33 is in a straight and naturally relaxed state, thereby greatly reducing the product material fatigue of the rope 33, so as to extend the service life of the rope 33 with normal working effect.

FIGS. 25 to 31, the unlocking transmission element 351 has two columns 3511, and any one of the columns 3511 can contact and drive the rope 33. When two or more columns 3511 drive the rope 33, it can effectively prevent the rope 33 and the columns 3511 from slipping, and form multiple contact points to balance the force, thereby ensuring the stability of the transmission.

Furthermore, the unlocking transmission element 351 is in a disc shape, and the two columns 3511 are arranged in a non-mirror symmetric manner relative to the rope 33, so that the two columns 3511 are staggered from each other along the initial direction of the rope 33 and form a channel 33a, and the rope 33 is at least partially inserted into the channel 33a. Specifically, the structure formed is that the two columns 3511 are spaced 180 degrees apart from each other, wherein the right side wall 35111 of one column 3511 contacts the rope 33 to retract the rope 33 on the right side of the unlocking transmission element 351 inwardly; the left side wall 35112 of the other column 3511 contacts the rope 33 to retract the rope 33 on the left side of the unlocking transmission element 351 inwardly, that is, the movement of the unlocking transmission element 351 can simultaneously retract the ropes 33 on both sides inwardly.

It is worth mentioning that, referring to FIG. 30, when the lock body assembly 32 is in the locked position state 32b, the rope 33 can be connected in series between the two lock body assemblies 32 in a non-inclined straight line, and at this time, it is not subjected to any force from the unlocking assembly 35, which is beneficial to reducing the pressure on the rope 33 and extending the service life of the rope 33. In addition, when the unlocking transmission element 351 is in the unlocking rotation process, referring to FIG. 31, the force of one column 3511 on the rope 33 is along the inner right direction 35a, and the force of the other column 3511 on the rope 33 is along the inner left direction 35b, that is, the forces on the rope 33 in the left and right directions cancel each other out, forming a double inward winding force, so that the effect of winding and collecting the rope is more stable and reliable, and the slippage phenomenon is completely eliminated, ensuring that the unlocking action is consistent and accurate.

FIGS. 24 to 27, the lock housing assembly 31 has two lock pin ports 3111, and each lock pin port 3111 is provided with one lock body assembly 32; the rope 33 is an integrated rope 33, and one end of the rope 33 is connected to one of the lock body assemblies 32, and the other end is connected to the other lock body assembly 32. It should be particularly noted that based on the aforementioned structural setting of this embodiment, what can be achieved in the application scheme is that when the lock body assembly 32 is in the locked position state 32b, the two lock body assemblies 32, the channel 33a and the rope 33 are distributed in the same straight line direction 36.

Application example 1 of this embodiment: two lock body assemblies 32 are matched with one unlocking assembly 35, wherein it is recommended that one unlocking assembly 35 is located in the middle position of the rope 33, and the unlocking assembly 35 is operated, and the unlocking assembly 35 exerts the same force on the ropes 33 on both sides, and can unlock the two lock body assemblies 32 at the same time through the same rope 33.

Application example 2 of this embodiment: two lock body assemblies 32 are matched with two unlocking assemblies 35, wherein it is recommended that the two unlocking assemblies 35 are symmetrically distributed on both sides of the rope 33, and operating any one of the unlocking assemblies 35 can simultaneously unlock the two lock body assemblies 32 through the same rope 33.

One of the advantages of Example 2 is that, since there are two unlocking components 35, they are distributed more widely, so the user can more closely contact and operate the unlocking component 35 that is closer to him/herself to achieve unlocking.

The second advantage is that when operating one unlocking component 35, the points of action on the ropes 33 on both sides are different. Specifically, the rope 33 close to the operated unlocking component 35 will rotate and wind, while the rope 33 close to the unlocking component 35 at the non-operated position will retract in a straight line. Therefore, even during the unlocking process, the rope 33 close to the unlocking component 35 at the non-operated position can always be in a natural relaxed state close to a straight line, and the unlocking component 35 at the corresponding position will not cause resistance to the rope 33 (mainly due to the existence of the channel 33a), and reduce the force loss in the transmission process. Therefore, operating one unlocking component 35 can still easily unlock the two lock body components 32 at the same time through the same rope 33.

A more detailed supplementary structural solution is as follows: Referring to FIGS. 27 to 34, the unlocking transmission element 351 includes a first plate 3512 and a second plate 3513, and the column 3511 is fixed between the first plate 3512 and the second plate 3513. Preferably, a supporting rib 3514 is further provided between the first plate 3512 and the second plate 3513 to strengthen the structural connection strength and provide better stability.

The first disk 3512 and the unlocking operating element 352 are connected to each other (preferably connected by a quadrangular prism 3521) so that the two form a fixed connection relationship and can maintain synchronous movement. The lock housing assembly 31 has a receiving groove 31211, and the second disk 3513 is movably arranged in the receiving groove 31211 (preferably connected by a circular rotating shaft 35132). Therefore, when the user drives the unlocking operating element 352, the first disk 3512 and the second disk 3513 can be driven to move (rotate) relative to the receiving groove 31211 (lock housing assembly 31).

Furthermore, a limiting area 31212 is provided on the groove wall of the accommodating groove 31211, and a guide block 35131 is convexly provided on the second disk 3513, and the guide block 35131 extends into the limiting area 31212, and the guide block 35131 can move (rotate) along the limiting area 31212. The angle of the limiting area 31212 is preferably 90°, and can also be 60° or 120°, etc. The angle is not specifically limited here, and is determined according to actual needs. When the guide block 35131 abuts against and limits one side wall of the limiting area 31212, it means that the lock body assembly 32 is switched to the locked position state 32b; when the guide block 35131 abuts against and limits the other side wall of the limiting area 31212, it means that the lock body assembly 32 is switched to the unlocked position state 32a.

A more preferred structural solution is provided for other related components, as follows:

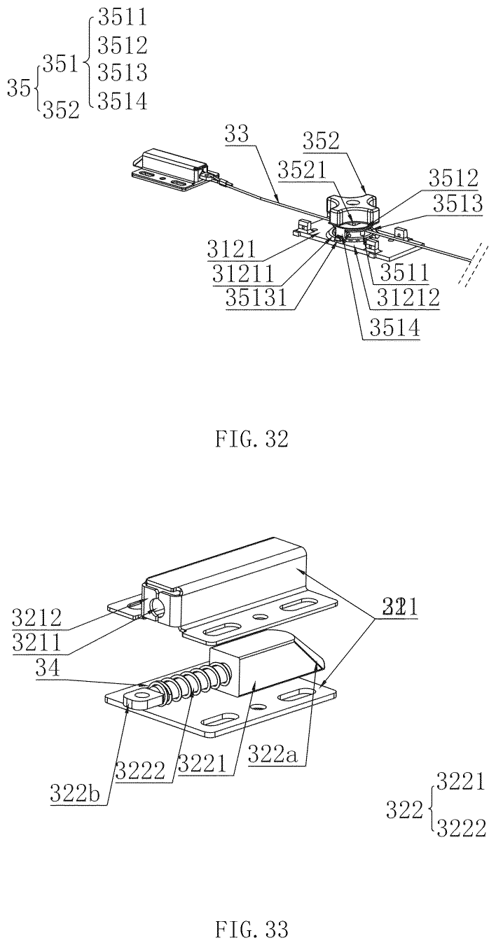

1. Lock body assembly 32: Referring to FIG. 33, it comprises: a lock pin housing 321 having a through hole 3211, and a lock pin body 322 movably disposed in the through hole 3211, wherein the lock pin housing 321 is fixed in the lock housing assembly 31;

One end of the locking pin body 322 is a locking end 322a, and the other end is a linkage end 322b. The linkage end 322b forms a transmission connection with the rope 33. The locking assembly 34 acts on the locking pin body 322 so that the lock body assembly 32 always has a movement tendency to switch from the unlocking position state 32a to the locking position state 32b.

Furthermore, the rear edge of the lock pin housing 321 is bent inward to form a stopper 3212, and the lock pin body 322 includes a lock pin block 3221 and a lock pin pull rod 3222 connected to each other, and the lock pin pull rod 3222 is connected to the rope 33; the locking assembly 34 is a spring, and the spring is sleeved on the lock core pull rod, and the spring abuts between the stopper 3212 and the lock pin block 3221. When resetting, the spring directly acts on the lock pin block 3221 to reset it, and the spring indirectly acts on the rope 33 and the unlocking assembly 35 through the lock body assembly 32, so that the rope 33 and the unlocking assembly 35 are reset. Preferably, when there are two (or three or more) unlocking assemblies 35, the unlocking assembly 35 is arranged at a position close to the lock body assembly 32, so that the force can effectively reduce the loss when it is transmitted at a close distance, so that the elastic force of a single spring can meet the reset force requirements of the lock body assembly 32, the rope 33 and the unlocking assembly 35.

2. Lock housing assembly 31: Referring to FIGS. 24 to 27, the lock housing assembly 31 includes a lock pin base 311, an unlocking housing kit 312, and a rope 33 cover 313, which are arranged in sequence from the outside to the inside. The lock housing assembly 31, which is composed of split parts, is easier to produce and mold, and reduces the difficulty of manufacturing and assembly. In addition, it can be transported in separate parts during transportation and assembled when needed, so that the split structure is easy to transport and can effectively reduce the probability of damage during transportation.

More specifically, the lock body assembly 32 is located in the lock pin base 311; the unlocking transmission element 351 is located in the unlocking shell kit 312, and the unlocking operating element 352 at least partially extends out of the unlocking shell kit 312 for easy user operation; a portion of the rope 33 is located in the rope 33 cover 313, and the other portion passes through the unlocking shell kit 312 and enters the lock pin base 311.

The preferred structural scheme of the unlocking housing kit 312 is that the unlocking housing kit 312 comprises an unlocking housing base 3121 and an unlocking housing cover 3122; the unlocking housing base 3121 and the unlocking housing cover 3122 are assembled with each other to form an inner cavity 3123 with spatial isolation and protection functions, and the unlocking transmission element 351 is arranged in the inner cavity 3123; the unlocking housing cover 3122 extends toward one side of the lock pin base 311 to form a lock pin cover 31221, and the lock pin base 311 has an upper end opening 3111, and the lock pin cover 31221 covers the upper end opening 3111. The setting of the upper end opening 3111 is conducive to the installation of the rope 33. After installation, the rope 33 is isolated from the outside through the cover of the lock pin cover 31221 to provide a protection function.

The above description is only a preferred embodiment of the present invention and does not limit the present invention in any way. Any simple modification, change and equivalent structural change made to the above embodiment according to the technical essence of the invention shall still fall within the protection scope of the technical solution of the present invention.

What is claimed is:

1. A truck covering system, comprising:
a car body frame mechanism (12) is configured to be mounted on a side wall of a truck car body (41), wherein the car body frame mechanism (12) has an open space (3711);
a covering system (11) is mounted on a carriage frame mechanism (12), the covering system (11) being composed of one or more panels (1101), and the covering system (11) having at least a flat position state (11a) and a standing position state (11b) relative to the carriage frame mechanism (12);
a clamp mechanism (23), wherein the clamp mechanism (23) can be respectively abutted against the carriage frame mechanism (12) and the cover system (11), and a distance (21a) is provided between the clamp mechanism (23) and the cover system (11);
a fastening mechanism (24), the fastening mechanism (24) acting on the clamp mechanism (23) and the cover system (11) to increase or decrease the spacing (21a), thereby forming a releasable connection between the cover system (11) and the carriage frame mechanism (12);
a latch mechanism (3) is attached to the cover system (11), and the latch mechanism (3) is releasably engaged with the carriage frame mechanism (12).

2. The truck covering system according to claim 1, further comprising:
a supporting element (13) mounted on the carriage frame mechanism (12);
a supporting element (14) which is mounted on the capping system (11), and the supporting element (14) moves along with the capping system (11);
when the covering system (11) is in a standing position state (11b), the abutting element (14) contacts the supporting element (13), so that the covering system (11) continuously maintains a standing position state (11b) relative to the carriage frame mechanism (12);
when the cover system (11) is in the flat position state (11a), the abutment element (14) is disengaged and separated from the support element (13).

3. The truck covering system according to claim 2 is characterized in that: both sides of the abutment element (14) extend outward to form side edges (1401), the side edges (1401) surround each other and form a first groove (1402), the support element (13) can be at least partially inserted into the first groove (1402), and the side wall of the support element (13) can contact the side edges (1401) so that the support element (13) and the abutment element (14) form a detachable connection.

4. The truck covering system according to claim 2 is characterized in that: a connecting seat (15) is provided on the supporting element (13), and a connecting belt (16) is provided on the covering system (11), and the connecting belt (16) is connected to an elastic buckle (17), and the elastic buckle (17) can be inserted into the connecting seat (15), so that the supporting element (13) and the covering system (11) are releasably connected through the connecting belt (16).

5. The truck covering system according to claim 2 is characterized in that the end surface of the supporting element (13) in contact with the abutting element (14) is a supporting end surface (1301), and the supporting end surface (1301) presents an arc shape (1301a) with a concave middle portion when viewed from a side.

6. The truck covering system according to claim 5, characterized in that the support element (13) is in the shape of a shark fin as a whole, and the support end surface (1301) is in a triangular shape (1301b) from a main side perspective.

7. The truck covering system according to claim 1, characterized in that: at least one of the panels (1101) is provided with a support seat (1102);
The carriage frame mechanism (12) is provided with a top rod (1201), and the top rod (1201) has a hinged end (12011) and a movable end (12012), the hinged end (12011) is connected to the carriage frame mechanism (12), and the movable end (12012) can be engaged with the support seat (1102) to keep the covering system (11) in a standing position (11b).

8. The truck covering system according to claim 1 is characterized in that: one of the clamp mechanism (23) and the car frame mechanism (12) has a hook (231), and the other has a hanging groove (2221); the clamp mechanism (23) is operated so that the hook (231) enters the hanging groove (2221), thereby hanging the clamp mechanism (23) on the car frame mechanism (12).

9. The truck covering system according to claim 8 is characterized in that: the hook (231) includes an insertion portion (2311) and a hook portion (2312), the hanging groove (2221) includes an opening portion (22211) and a hanging portion (22212), the insertion portion (2311) is correspondingly inserted into the opening portion (22211), the hook portion (2312) is correspondingly hung in the hanging portion (22212), and the hook portion (2312) abuts against the inner wall of the hanging portion (22212) to form a limited anti-slip fit.

10. The truck covering system according to claim 8, characterized in that: the clamp mechanism (23) is in a “C” shape as a whole, the clamp mechanism (23) has a first arm (232) on the left side and a second arm (233) on the right side, and a receiving portion is formed between the first arm (232) and the second arm (233);
The clamp mechanism (23) also has a protrusion (234), and the protrusion (234) divides the accommodating part into a first accommodating part (23a) and a second accommodating part (23b); the hook (231) and the carriage frame mechanism (12) are correspondingly arranged in the first accommodating part (23a), and the fastening mechanism (24) is correspondingly arranged in the second accommodating part (23b).

11. The truck covering system according to claim 8, characterized in that: the fastening mechanism (24) comprises a threaded fastener (241), an abutment seat (242) and a knob (243);
the clamp mechanism (23) is provided with a through hole (235), the capping system (11) is provided with a fixing hole (211), and the threaded fastener (241) passes through the through hole (235) and is screwed into the fixing hole (211);
the abutment seat (242) is threadedly connected to the upper end of the threaded fastener (241), and the abutment seat (242) can be fixedly connected to the lower end of the capping system (11);
the knob (243) is fixedly connected to the lower end of the threaded fastener (241), and the knob (243) is operated in the tightening direction to drive the threaded fastener (241) to rotate and rise, so that the knob (243) abuts against the lower end of the clamp mechanism (23), and the clamp mechanism (23) is close to the capping system (11).

12. The truck covering system according to claim 8, characterized in that: the carriage frame mechanism (12) comprises a carriage side rail (221) and a lateral frame (222), and a sealing member (223), and the carriage side rail (221) and the lateral frame (222) are detachably engaged;
the carriage side rail (221) is provided with a first sealing groove (2211), the lateral frame (222) is provided with a second sealing groove (2222), the lower end of the sealing member (223) has a first sealing portion (2231) and a second sealing portion (2232), the first sealing portion (2231) is embedded in the first sealing groove (2211), and the second sealing portion (2232) is embedded in the second sealing groove (2222);
one or more sealing convex strips (2233) are protruding from the upper end of the sealing component (223), and the sealing convex strips (2233) can abut against the cover system (11) to form a sealing fit between the carriage frame mechanism (12) and the cover system (11).

13. The truck covering system according to claim 1, characterized in that the latch mechanism (3) comprises:
a lock housing assembly (31) having a lock pin port (3111);
a lock body assembly (32) is assembled at the lock pin port (3111), and the lock body assembly (32) can move relative to the lock pin port (3111), so that the lock body assembly (32) has at least an unlocked position state (32a) and a locked position state (32b);
a rope (33) which is in transmission connection with the lock body assembly (32);
The unlocking assembly (35) acts on the lock assembly (32) through the rope (33); the unlocking assembly (35) comprises:
an unlocking transmission element (351) is movably arranged in the lock housing assembly (31), the rope (33) passes through the unlocking transmission element (351), and the unlocking transmission element (351) has one or more columns (3511), and the columns (3511) can abut against the rope (33) and pull the rope (33);
an unlocking operating element (352) is connected to the unlocking transmission element (351); the user controls the unlocking operating element (352) to make the unlocking transmission element (351) move relative to the lock housing assembly (31), so that the unlocking transmission element (351) acts on the lock body assembly (32) through the rope (33), so that the lock body assembly (32) switches from the locked position state (32b) to the unlocked position state (32a); when the lock body assembly (32) is in the unlocked position state (32a), the lock body assembly (32) and the carriage frame mechanism (12) are staggered with each other, and the cover system (11) can move freely to switch from the flat position state (11a) to the standing position state (11b), and at this time, the release position is open space (3711);
the locking assembly (34) acts on the lock body assembly (32) so that the lock body assembly (32) always has a movement tendency to switch from the unlocked position state (32a) to the locked position state (32b); when the lock body assembly (32) is in the locked position state (32b), the lock body assembly (32) forms a limit fit with the carriage frame mechanism (12) to limit the movement of the cover system (11) and keep it in the flat position state (11a), at which time the cover system (11) continues to cover the open space (3711).

14. The truck covering system according to claim 13 is characterized in that: the unlocking transmission element (351) has two of the columns (3511), and the unlocking transmission element (351) is disc-shaped, and the two columns (3511) are arranged in a non-mirror symmetric manner relative to the rope (33), so that the two columns (3511) are staggered with each other along the initial direction of the rope (33) and form a channel (33a), and the rope (33) is at least partially inserted into the channel (33a).

15. The truck covering system according to claim 14, characterized in that: the lock housing assembly (31) has two lock pin ports (3111), and each lock pin port (3111) is provided with one of the lock body assemblies (32);
the rope (33) is an integrated rope (33), and one end of the rope (33) is connected to one of the lock body components (32), and the other end is connected to another lock body component (32).

16. The truck covering system according to claim 13, characterized in that: the unlocking transmission element (351) comprises a first plate (3512) and a second plate (3513), and the column (3511) is fixed between the first plate (3512) and the second plate (3513);
the first disk (3512) and the unlocking operating element (352) are connected to each other;
the lock housing assembly (31) has a receiving groove (31211), and the second disk (3513) is movably disposed in the receiving groove (31211).

17. The truck covering system according to claim 16 is characterized in that: a limiting area (31212) is opened on the groove wall of the accommodating groove (31211), a guide block (35131) is protrudingly provided on the second plate (3513), the guide block (35131) extends into the limiting area (31212), and the guide block (35131) can move along the limiting area (31212).

18. The truck covering system according to claim 13, characterized in that: the lock body assembly (32) comprises: a lock pin housing (321) having a through hole (3211), a lock pin body (322) movably inserted into the through hole (3211), and the lock pin housing (321) is fixed in the lock housing assembly (31);
one end of the lock pin body (322) is a locking end (322a), and the other end is a linkage end (322b), the linkage end (322b) forms a transmission connection with the rope (33), and the locking assembly (34) acts on the lock pin body (322) so that the lock body assembly (32) always has a movement tendency to switch from an unlocked position state (32a) to a locked position state (32b);
the rear edge of the lock pin housing (321) is bent inward to form a stopper (3212), and the lock pin body (322) includes a lock pin block (3221) and a lock pin pull rod (3222) connected to each other, and the lock pin pull rod (3222) is connected to the rope (33);
the locking component (34) is a spring, which is sleeved on the lock core pull rod and abuts between the stopper (3212) and the lock pin block (3221).

19. The truck covering system according to claim 13, characterized in that: the lock housing assembly (31) comprises a lock pin base (311), an unlocking housing kit (312) and a rope (33) cover (313) which are arranged in sequence from outside to inside;
the lock body assembly (32) is located in the lock pin base (311);
the unlocking transmission element (351) is located in the unlocking housing assembly (312), and the unlocking operating element (352) at least partially extends out of the unlocking housing assembly (312);
a portion of the rope (33) is located in the rope (33) cover (313), and another portion passes through the unlocking housing kit (312) and enters the lock pin base (311).

20. The truck covering system according to claim 19, characterized in that: the unlocking housing kit (312) comprises an unlocking housing base (3121) and an unlocking housing cover plate (3122);
the unlocking housing base (3121) and the unlocking housing cover (3122) are assembled with each other to form an inner cavity (3123), and the unlocking transmission element (351) is arranged in the inner cavity (3123);
the unlocking shell cover plate (3122) extends toward one side of the lock pin base (311) to form a lock pin cover body (31221), the lock pin base (311) has an upper end opening (3111), and the lock pin cover body (31221) covers the upper end opening (3111).
